(19) United States
(12) Patent Application Publication
(10) Pub. No.: US 2012/0058168 A1
(43) Pub. Date: Mar. 8, 2012

(54) Animal Attractant

(76) Inventor: Robert M. Stanley, New Albany, IN (US)

(21) Appl. No.: 13/209,079

(22) Filed: Aug. 12, 2011

Related U.S. Application Data
(60) Provisional application No. 61/373,079, filed on Aug. 12, 2010.

(51) Int. Cl. A01N 25/10; A01N 25/02

(52) U.S. Cl. 424/409; 424/84

(57) ABSTRACT

Disclosed herein are compositions and methods useful for attracting animals to a site determined by the user of the compositions and method disclosed herein. Disclosed are compositions that contain an absorbent material and an animal attractant. The animal attractant may be in the form of a liquid and may have a urine scent, a food scent, or a combination thereof.

### PRIORITY INFORMATION

This application claims priority to U.S. Application Ser. No. 61/373,079, filed Aug. 12, 2010, the contents of which are incorporated in entirety by reference herein.

### BRIEF SUMMARY OF THE INVENTION

Disclosed herein are compositions, methods and kits useful for the attraction of animals to a desired location.

### DETAILED DESCRIPTION OF THE INVENTION

The composition, methods and kits disclosed herein may be used as a non-species-specific animal attractant that may be used by outdoor enthusiasts. The product may be used to attract animals to land areas in which the users will be waiting for the animals. Users will primarily be hunters, but may include anyone desiring to attract animals to a specific place such as photographers. It may be useful as a light-weight, relatively inexpensive animal attractant, and may be carried into the field over long distances with relative ease. Moreover, the product may hold an animal or food scent for a longer period of time than simply pouring the animal urine or food scent directly onto the ground as is conventionally done.

In one aspect, a composition containing an absorbent material and an animal attractant is disclosed.

The absorbent material may be a material selected from a crosslinked polyacrylamide polymer, a crosslinked polyacrylate polymer; a polyacrylamide/polyacrylate polymer; a long chain linear polymer; a cationic polymer; peat moss, a clay based material, a silica based material, a cellulose material, or a combination thereof. The absorbent material may be capable of absorbing the animal attractant, and may release the scent of the animal attractant over a period of greater than about 30 days, or greater than about 60 days, or greater than about 90 days, or, in other aspect, the length of a typical hunting season. In further aspects, the absorbent material may be a crosslinked polyacrylamide polymer further containing a salt, such as a potassium salt, a sodium salt, or a combination thereof. In one aspect, the absorbent material comprises about 99% crosslinked polyacrylamide and an inert ingredient. In a further aspect, the absorbent material comprises about 99.7% crosslinked polyacrylamide and about 0.3% of an inert ingredient.

In one aspect, the absorbent material may be capable of absorbing greater than about 10, or greater than about 50, or greater than about 75, or greater than about 100, or greater than about 150, or greater than about 200 times its weight in water. In this manner, the absorbent material may be capable of absorbing a relatively large amount of an animal attractant, the scent of which can be released over time.

The absorbent material may take a variety of forms. In one aspect, the absorbent material is in the form of a granulate. In this form, the absorbent material may be suited for distributing on the surface of an area, such as the ground of a site to which an animal is desired to be attracted. The granulate may have an average particle size of about 50 microns to about 500 microns in diameter. The granulate may be Soil Moist Fines™ (available from JRM Chemical, Inc, Cleveland Ohio), having a size of 50 to 500 microns, formulated from crosslinked polyacrylamide, potassium based.

In another aspect, the absorbent material may be in the form of a disk. The size and shape of the disk described herein is not intended to be limiting, and may take a variety of different shapes and sizes. In this form, the absorbent material may have a high surface area and be suited to burying inches (1-6 inches) below the soil, such that an animal of interest may be attracted to the scent embedded in the disk, yet unable to move or disturb the disk. In one aspect, the material is a Soil Moist Polymer Disk™ (available from JRM Chemical, Inc, Cleveland Ohio), having a diameter of about 1 to 2 inches. The disk may be larger or smaller, as desired by the user. The Soil Moist Polymer disk is a non-toxic polyacrylamide containing bisacrylamide crosslinker.

In yet another aspect, the absorbent material may be of a generally elongated shape. In this form, the absorbent material may be suited for hanging from an area, such as a branch, such that an animal of interest may find the hanging material and deposit its own scent by rubbing against the hanging absorbent material, thereby causing other animals to be attracted to the area by the additional scent. In one aspect, the absorbent material may be a Soil Moist Spike™ (available from JRM Chemical, Inc, Cleveland Ohio). The spike may be made from polyacrylamide and crosslinked with bisacrylamide.

The compositions, methods, and kits herein may employ an animal attractant. In one aspect, the animal attractant may attract an animal selected from deer, fox, coyote, raccoons, elk, mule deer, antelope, or a combination thereof. The animal attractant may comprise a material having a scent selected from a food scent, a urine scent, or a combination thereof. The animal attractant may be in a liquid or other suitable form such that the animal attractant may be applied to the absorbent material.

In one aspect, the composition may comprise an animal attractant and an absorbent material, wherein the animal attractant is present in a ratio of about 0.5:1 to about 1:1. Other ratios may be employed and may be determined by routine experimentation.

### Method of Using the Disclosed Compositions

In another aspect, a method of attracting an animal to a desired site is disclosed. In this aspect, the method may comprise the steps of contacting an absorbent material having the properties disclosed herein with an animal attractant and placing an absorbent material at a desired site. The absorbent material retains the animal attractant, releasing the animal attractant over a period of time. The period of time may be greater than about 30 days, or greater than about 60 days, or greater than about 90 days, or for the length of the hunting season of interest.

In one aspect, the contacting step may comprise spraying the absorbent material with the animal attractant. Any other suitable means of contacting the absorbent material with the animal attractant may be employed and will be readily appreciated by one of ordinary skill in the art. The placing step may be selected from placing the absorbent material underneath the soil of a desired site; at the surface of the soil of a desired site; or hanging (for example, from a tree branch) at a desired site, or a combination of all three. The absorbent material may be in a form selected from, for example, a disk, a granulate, and an elongate rod. In one aspect, the placing step may be selected from placing the absorbent material in the form of a disk underneath the soil of the desired site; placing the absorbent material in the form of a granulate at the surface of the soil of the desired site; placing the absorbent material in the form of an elongate rod; and a combination thereof.

### Kit

In one aspect, a kit containing an absorbent material and an animal attractant is disclosed. The absorbent material and animal attractant may be any of those described herein, and may take any forms as described above. The kit may further contain instructions for the user in accordance with the methods set forth herein. In one aspect, the kit contains an absorbent material in the form of a granulate; an absorbent material in the form of a disk; and an absorbent material in the form of an elongated rod; and an animal attractant.

All percentages and ratios are calculated by weight unless otherwise indicated.

All percentages and ratios are calculated based on the total composition unless otherwise indicated.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “20 mm” is intended to mean “about 20 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

### EXAMPLES

### Example I

A dry granular material made up of 99.7% crosslinked polyacrylamide and 0.3% inert ingredients is mixed with animal urine attractive to the animal species which the user desires to attract to a particular land area. Approximately one tablespoon of the granular material is mixed with approximately one ounce of the animal urine. The mixture is then immediately mixed into the soil at the site to the land area of interest. The dry granular material absorbs and retains the liquid and its scent for up to 90 days to attract the desired animal to the area.

### Example II

An area is located to which an animal is desired to be attracted. SoilMoist Fines™ (manufactured by JRM Chemical, Inc., Cleveland Ohio) is mixed into the upper layer of the soil. An equal amount of animal urine is sprayed onto the layer of soil containing the SoilMoist Fines™.

What is claimed is:

1. A composition comprising
a. an absorbent material, wherein said absorbent material comprises a material selected from a crosslinked polyacrylamide polymer; a crosslinked polyacrylate polymer; a polyacrylamide/polyacrylate polymer; a long chain linear polymer; a cationic polymer; peat moss; a clay based material; a silica based material; a cellulose material; or a combination thereof; and
b. an animal attractant;
wherein said absorbent material is capable of absorbing said animal attractant; and
wherein said absorbent material is capable of releasing a scent of said animal attractant over a period of greater than about 30 days.

2. A composition according to claim 1 wherein said crosslinked polyacrylamide polymer comprises a salt.

3. A composition according to claim 1 wherein said crosslinked polyacrylamide polymer comprises a potassium or sodium salt.

4. A composition according to claim 1, wherein said absorbent material is in the form of a disk.

5. A composition according to claim 1, wherein said absorbent material is of a generally elongate shape.

6. A composition according to claim 1 wherein said absorbent material is capable of absorbing greater than about 10 times its weight in water.

7. A composition according to claim 1 wherein said animal attractant attracts an animal selected from deer, fox, coyote, raccoons, elk, mule deer, antelope, or a combination thereof.

8. A composition according to claim 1 wherein said animal attractant comprises a material comprising a scent selected from a food scent, a urine scent, or a combination thereof.

9. A composition according to claim 1 wherein said animal attractant is in liquid form.

10. A composition according to claim 1 comprising said animal attractant, wherein said absorbent material and said animal attractant is present in a ratio of about 0.5 to about 1.0 v/v.

11. A method of attracting an animal to a desired site, comprising the steps of
a. contacting said absorbent material with an animal attractant; and
b. placing said absorbent material at said desired site.

12. A method according to claim 11 wherein said absorbent material retains said animal attractant and releases said animal attractant over a period of time greater than about 30 days.

13. A method according to claim 11 wherein said animal attractant comprises a liquid comprising a food or a urine scent.

14. A method according to claim 11 wherein said liquid and said absorbent material are present in a ratio of about 0.5 to about 1 v/v.

15. A method according to claim 11 wherein said contacting step comprises spraying said absorbent material with said animal attractant.

16. A method according to claim 11 wherein said placing step comprises placing said absorbent material in the form of a disk underneath the soil of said desired site.

17. A method according to claim 11 wherein said absorbent material is in a form selected from a disk, a granulate, and an elongate rod.

18. A method according to claim 11 wherein placing step is selected from placing said absorbent material in the form of a disk underneath the soil of said desired site; placing said absorbent material in the form of a granulate at the surface of said the soil of said desired site; placing said absorbent material in the form of an elongate rod; and a combination thereof.

19. A kit comprising an absorbent material and an animal attractant, wherein said absorbent material is selected from a crosslinked polyacrylamide polymer, a crosslinked polyacrylate polymer; a polyacrylamide/polyacrylate polymer; a long chain linear polymer; a cationic polymer; peat moss, a clay based material, a silica based material, a cellulose material, or a combination thereof;
wherein said absorbent material is in a form selected from a particulate; a disk; and a generally elongated shape; and
wherein said animal attractant is selected from a material that releases a urine scent, a food scent, or a combination thereof.
